(19) United States
(12) Patent Application Publication
(10) Pub. No.: US 2008/0094572 A1
(43) Pub. Date: Apr. 24, 2008

(54) Vision Correction Device And Method For Vision Correction

(76) Inventor: Dar-Chung Lai, Gueishan Township (TW)

Correspondence Address: LIN & ASSOCIATES INTELLECTUAL PROPERTY, INC., P.O. BOX 2339, SARATOGA, CA, 95070-0339, US

(21) Appl. No.: 11/551,242

(22) Filed: Oct. 20, 2006

(51) Int. Cl. G02C 7/02

(52) U.S. Cl. 351/177

(57) ABSTRACT

A vision correction device includes a mount and a correction part having a correction base, a first pad and a second pad, wherein the first pad and the second pad are disposed on the correction base, and the correction base is telescoped into the mount. A method for vision correction includes the following steps: (1) providing a vision correction device pressed on the eyes; (2) pressing the vision correction device on the eye continuously to get a clear vision; (3) keeping the clear vision for a predetermined time to activate a feedback reaction of brain to get used to a state of normal vision; and (4) removing the vision correction device from the eye, the eye restoring an original vision and the feedback reaction of brain adjusting the original vision back to the normal vision.

### BACKGROUND OF THE INVENTION

1. Field of the Invention

The present invention relates generally to a vision correction device and a method for vision correction, and in particular to a vision correction device and a method for vision correction for restoring a normal vision.

2. The Prior Arts

With reference to FIGS. 1A, eyeglasses 1, which comprise concave lenses or convex lenses, are one of conventional devices or methods for vision correction. The lens is placed in front of an eye 2 and refracts light to focus a sharp image onto the retina 3. Another correction method is laser surgery. It utilizes a laser beam 5 to vaporize portion of a cornea 4. Therefore, it changes the curvature of the cornea 4 as shown in FIG. 1B. The focal point of the eye is changed so that it focuses perfectly on the retina 3, just like a normal eye. Still another vision correction device and method is orthokeratology. It is a non-surgical procedure, which utilizes a rigid contact lens 6 to reshape the cornea 4 over time to correct the vision as shown in FIG. 1C. When the lens is removed, the cornea temporarily retains the new shape, so the user can see clearly without the lens. Most of the other correction therapies utilize medicines or physical methods to adjust an axial length of eye or utilize ciliary muscles to adjust the curvature of the crystalline lens. Thus, the improvement of vision is limited.

Accordingly, the conventional methods for vision correction are not effective. When a user wears eyeglasses his eyes will automatically adjust to the lenses he wears. Although the eyeglasses may refract the light to focus the images onto the retinas, the lenses do all the work. The eyes work as if there is no lens. Since the eyes do not make any adjustment, it makes eyes depend on the eyeglasses. Hence, the eyes do not restore the normal vision and even get worse. The laser surgery involves risks and side effects, such as aberration, and the orthokeratology may also lead to side effect of eye infection (also called corneal ulcer). Therefore, the conventional methods for vision correction and devices are unable to effectively restore the vision back to normal.

### SUMMARY OF THE INVENTION

A primary objective of the present invention is to provide a vision correction device, which presses a user's eyes to change an axial length of eyes with two pads, thereby temporarily restoring the user's vision to normal. When the vision correction device is removed, brain activates a feedback reaction to adjust the axial lengths of eyes, curvatures of crystalline lenses, dilation or contraction of pupils and convergence of the visual axes according to the corrected vision. Therefore it fulfills the objective of restoring normal vision.

According to the primary objective described above, a vision correction device constructed in accordance with the present invention comprises a mount in a hollow cylinder shape and a correction part having a correction base, a first pad and a second pad. The first pad and the second pad are disposed on the correction base, and the correction base is telescoped into the mount.

Moreover, a method for vision correction according to the present invention comprises the following steps: (1) providing a vision correction device pressed on an eye; (2) pressing the vision correction device on the eye continuously to adjust an axial length of the eye until getting a clear vision; (3) keeping the normal vision for a predetermined time to stimulate the brain to remember the axial length of eye, curvature of the lens, the contraction or dilation of pupil, and the convergence of the visual axis needed for the normal vision; and (4) removing the vision correction device from the eye, the eye restoring the original vision and the feedback reaction of brain adjusting the axial length of the eye, the curvature of the crystalline lens, contraction or dilation of the pupil, and convergence of the visual axes to a state of the normal vision.

When the first pad and the second pad press on a lower eyelid and an upper eyelid, respectively, the axial length of eye is changed. The eye restores normal vision temporarily, and the brain gets used to and remembers a state of normal vision. When the vision correction device is removed, the eye restores an original vision. The feedback reaction of brain actively adjusts the eyes to the remembered normal visional state. Repeatedly pressing the vision correction device on the eye for a prolonged period enhances the feedback reaction of brain. When the user is not wearing the vision correction device, the enhanced feedback reaction of brain adjust the axial length of the eye, the curvature of the crystalline lens, contraction or dilation of the pupil, and convergence of the visual axes to the state of normal vision. Therefore, the eyes restore the normal vision gradually and discard the vision correction device eventually. The present invention does not have the disadvantages or side effects of the conventional devices and methods.

### BRIEF DESCRIPTION OF THE DRAWINGS

The present invention will be apparent to those skilled in the art by reading the following detailed description of preferred embodiments thereof, with reference to the attached drawings, in which:

FIG. 1A is a schematic view showing eyeglasses in use;

FIG. 1B is a schematic view showing laser surgery;

FIG. 1C is a schematic view showing orthokeratology;

FIG. 2A is an exploded view showing a vision correction device according to a first embodiment of the present invention;

FIG. 2B is a schematic view showing the vision correction device according to the first embodiment of the present invention;

FIG. 3A is a schematic view showing the vision correction device in use according to the first embodiment of the present invention;

FIG. 3B is a schematic view showing the vision correction device attached to eyeglasses according to the first embodiment of the present invention;

FIG. 4A is an exploded view showing a vision correction device according to a second embodiment of the present invention;

FIG. 4B is a schematic view showing the vision correction device in use according to the second embodiment of the present invention;

FIG. 4C is a schematic view showing an activating module of the vision correction device according to the second embodiment of the present invention;

FIG. 5A is an exploded view showing a vision correction device according to a third embodiment of the present invention;

FIG. 5B is a schematic view showing the vision correction device in use according to the third embodiment of the present invention;

FIG. 6A is an exploded view showing a vision correction device according to a fourth embodiment of the present invention;

FIG. 6B is a schematic view showing the vision correction device in use according to the fourth embodiment of the present invention;

FIG. 7A is an exploded view showing a vision correction device according to a fifth embodiment of the present invention;

FIG. 7B is a schematic view showing the vision correction device in use according to the fifth embodiment of the present invention;

FIG. 8A is a schematic view showing the relation between the axial length of eye and the size of the pupil when looking the object at different distance;

FIG. 8B is a schematic view showing the characteristics of the visual axes of eyes with respect to the distance between the object and the eyes;

FIG. 9A is a schematic view showing the vision correlative motion of an eye with a normal vision looking at an object closer by and an object far away;

FIG. 9B is a schematic view showing the vision correlative motion of a nearsighted eye looking at an object closer by and an object far away;

FIG. 9C is a schematic view showing the vision correlative motion of a nearsighted eye wearing a vision correction device looking at an object closer by and an object far away;

FIG. 9D is a schematic view showing the vision correlative motion of a nearsighted eye wearing a vision correction device with a semi-mask looking at an object closer by and an object far away;

FIG. 9E is a schematic view showing the vision correlative motion of a nearsighted eye wearing a vision correction device with an aperture lens looking at an object closer by and an object far away;

FIG. 9F is a schematic view showing the vision correlative motion of a nearsighted eye wearing a vision correction device with an illuminant looking at an object closer by and an object far away;

FIG. 9G is a schematic view showing the vision correlative motion of a nearsighted eye wearing a vision correction device with an integrating module, looking at an object closer by and an object far away;

FIG. 9H is a schematic view showing the vision correlative motion of a nearsighted eye wearing a vision correction device with an integrating module and eyeglasses, looking at an object closer by and an object far away;

FIG. 10 is a flow chart showing a method for vision correction according to a first embodiment of the present invention;

FIG. 11 is a flow chart showing a method for vision correction according to a second embodiment of the present invention;

FIG. 12 is a flow chart showing a method for vision correction according to a third embodiment of the present invention;

FIG. 13 is a flow chart showing a method for vision correction according to a fourth embodiment of the present invention;

FIG. 14 is a flow chart showing a method for vision correction according to a fifth embodiment of the present invention; and

FIG. 15 is a flow chart showing a method for vision correction according to a sixth embodiment of the present invention.

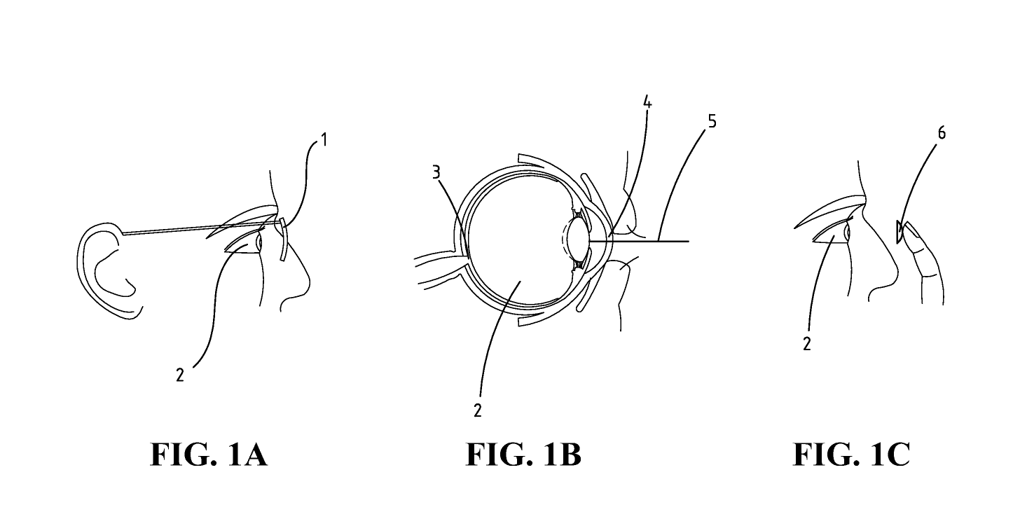

### DETAILED DESCRIPTION OF THE PREFERRED EMBODIMENT

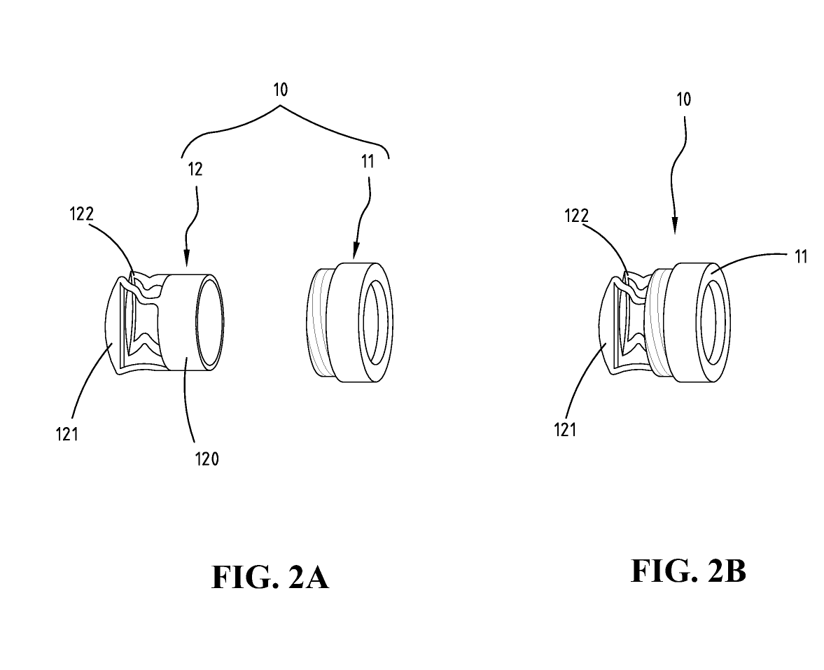

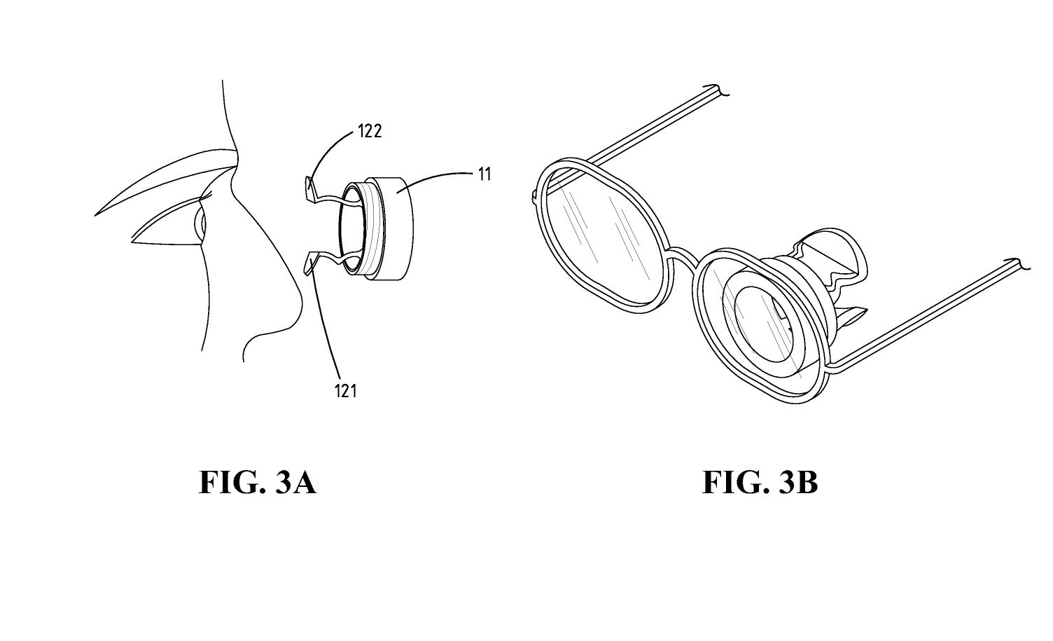

Referring to FIGS. 2A, 2B, 3A and 3B, the vision correction device 10 in accordance with the present invention comprises a hollow-cylinder-shaped mount 11 and a correction part 12. The mount 11 has a conjunction part 110 (not shown) disposed therein. The correction part 12 comprises a correction base 120, a first pad 121 and a second pad 122. The first pad 121 and the second pad 122 are disposed on the correction base 120, and the correction base 120 of the correction part 12 is telescoped into the conjunction part 110 of the mount 11. The correction part 12 is made of an elastic material. As shown in FIG. 3A, the first pad 121 and the second pad 122 press on the lower eyelid and the upper eyelid, respectively. The first pad 121 and the second pad 122 are made of an elastic material. The sections connecting the first pad 121 and the second pad 122 with the correction base 120 are deformed when the pressure applied on the eyes is too high. Therefore the pressure applied on the eyes is relieved. This deformation mechanism prevents the eyes from being hurt by the vision correction device 10 due to the high pressure. The pressure applied on the eyes is adjusted to achieve the normal vision. As shown in FIG. 3B, the mount 11 may be disposed on eyeglasses.

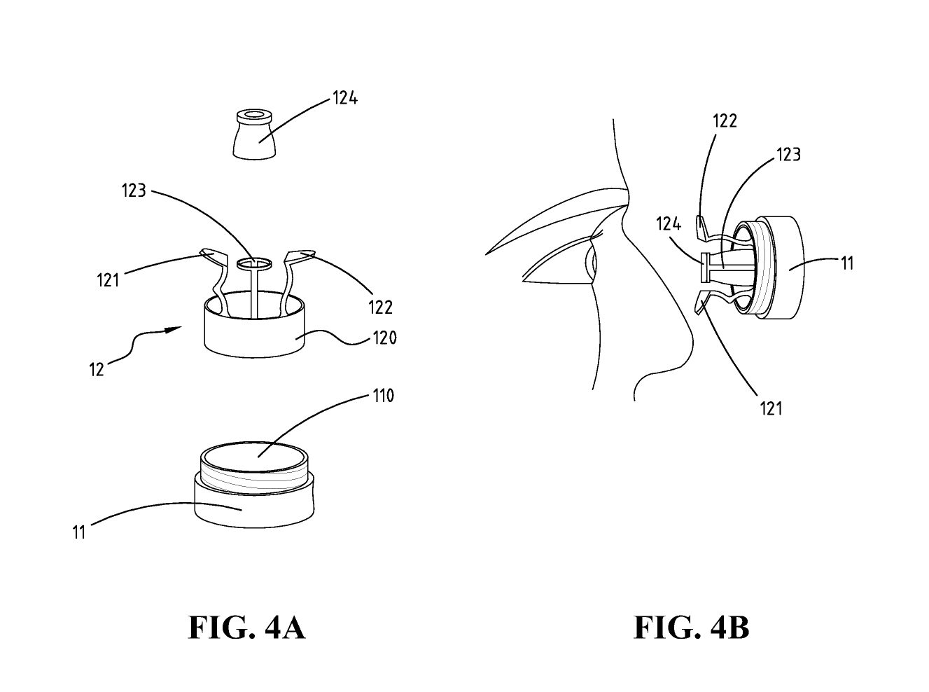

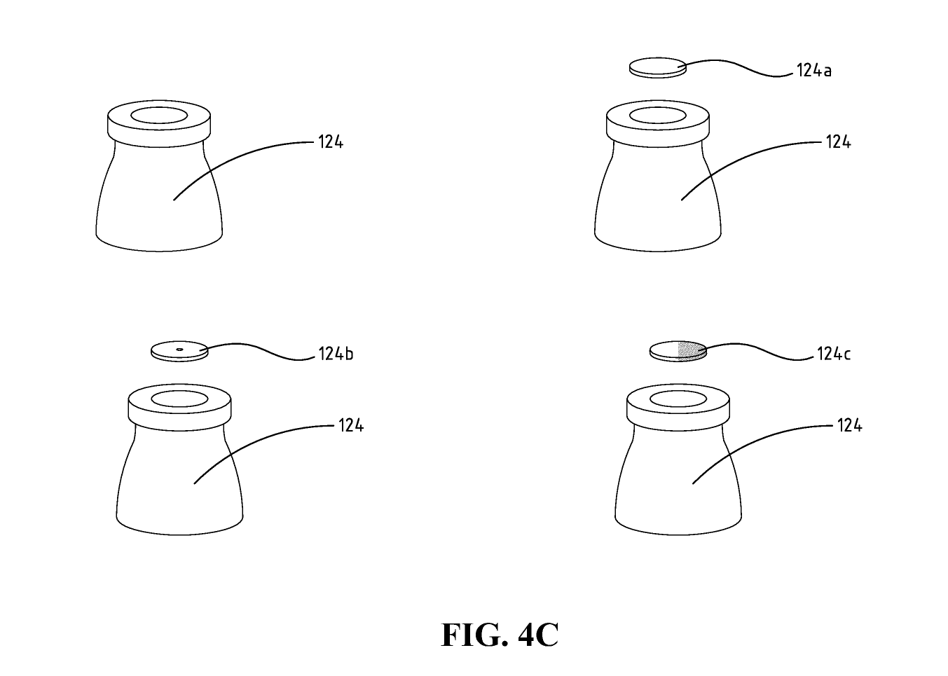

Referring to FIGS. 4A, 4B and 4C, a vision correction device 10 according to a second embodiment of the present invention comprises a mount 11 shaped into a hollow cylinder and a correction part 12. The mount 11 includes a conjunction part 110 disposed therein. The correction part 12 comprises a correction base 120, a first pad 121, a second pad 122, a correction ring 124 and a correction ring hoop 123. The first pad 121 and the second pad 122 are disposed on the correction base 120. The correction ring hoop 123 is disposed on the correction base 120 and between the first pad 121 and the second pad 122. The correction ring 124 is telescoped into the correction ring hoop 123. The correction base 120 of the correction part 12 is telescoped into the conjunction part 110 of the mount 11. As shown in FIG. 4B, the first pad 121 and the second pad 122 press on the lower eyelid and the upper eyelid, respectively. The first pad 121, the second pad 122, and the correction ring hoop 123 are made of an elastic material. The sections connecting the first pad 121 and the second pad 122 with the correction base 120 are deformed when the pressure applied on the eyes is too high. Therefore the pressure applied on the eyes is relieved. Moreover, the correction ring 124 presses on the eyelid or the cornea slightly to adjust the curvature of the cornea. The sections connecting the correction ring hoop 123 with the correction base 120 are deformed when the pressure applied on the eyes is too high. Therefore the pressure applied on the eyes is relieved. These deformation mechanisms prevent the eyes from being hurt by the vision correction device 10 due to the high pressure. The pressure applied on the eyes is adjusted to achieve the normal vision. As shown in FIG. 4C, the correction ring 124 may further comprise an activating module, such as a correction lens 124a, an aperture lens 124b and a semi-mask 124c, to improve the adjusting mechanism of vision correction device 10. The correction lens 124a is a lens pressing on the eye to change the axial length of the eye. The aperture lens 124b is a lens having an aperture at the center thereof. The semi-mask 124c is a piece blocking part of the vision.

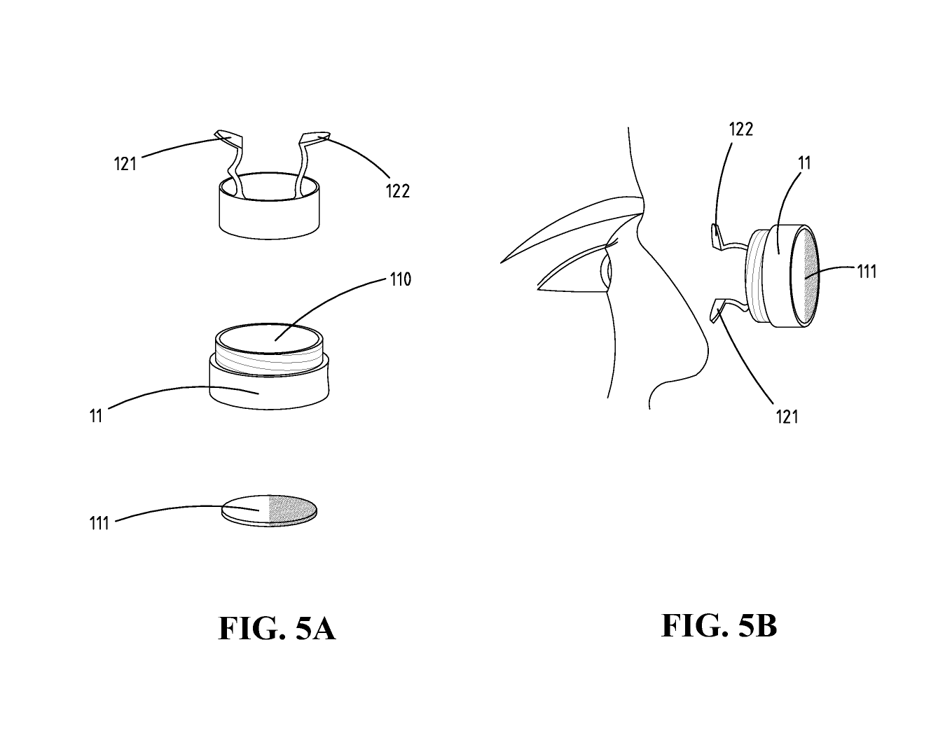

Referring to FIGS. 5A and 5B, a vision correction device 10 in accordance with a third embodiment of the present invention comprises a mount 11 shaped into a hollow cylinder and a correction part 12. The mount 11 has a conjunction part 110 and a lens module 111 disposed therein. The correction part 12 comprises a correction base 120, a first pad 121 and a second pad 122. The first pad 121 and the second pad 122 are disposed on the correction base 120. The correction base 120 of the correction part 12 is telescoped into the conjunction part 110 of the mount 11. As shown in FIG. 5B, the first pad 121 and the second pad 122 press on the lower eyelid and the upper eyelid, respectively. The correction part 12 is made of an elastic material. The sections connecting the first pad 121 and the second pad 122 with the correction base 120 are deformed when the pressure applied on the eyes is too high. Therefore the pressure applied on the eyes is relieved. This deformation mechanism prevents the eyes from being hurt by the vision correction device 10 due to the high pressure. The pressure applied on the eyes is adjusted to achieve the normal vision. Moreover, the lens module 111 of the mount 11 includes a variety of lens, such as a semi-mask, an aperture lens, etc., for different needs. For example, the semi-mask is used to train the adjusting ability of looking at an object closer by or an object far away. The aperture lens is used to train brain to merge two images on the retinas into one.

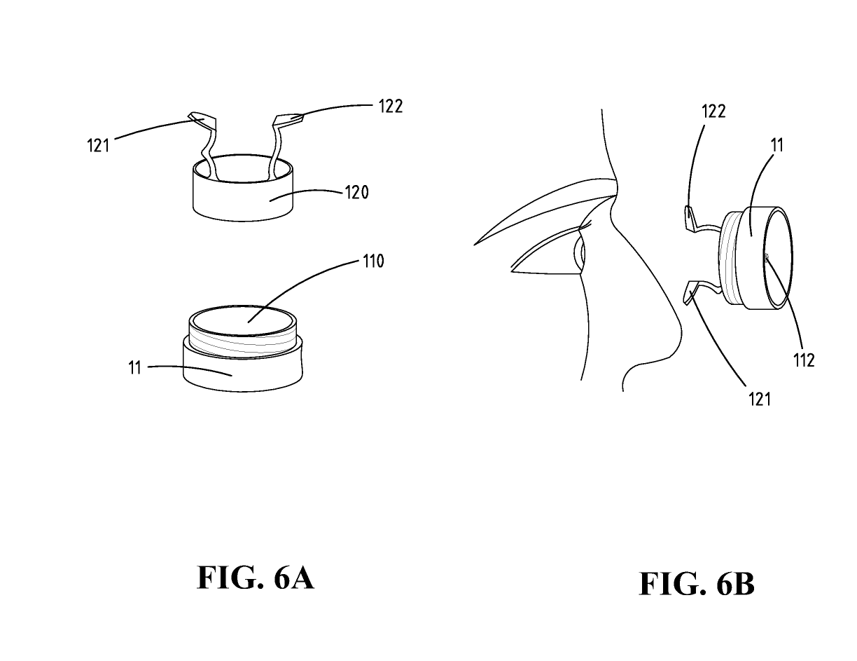

Referring to FIGS. 6A and 6B, a vision correction device 10 according to a fourth embodiment of the present invention comprises a mount 11 shaped into a hollow cylinder and a correction part 12. The mount 11 includes a conjunction part 110 and an illuminant 112 disposed therein. The correction part 12 comprises a correction base 120, a first pad 121 and a second pad 122. The first pad 121 and the second pad 122 are disposed on the correction base 120. The correction base 120 of the correction part 12 is telescoped into the conjunction part 110 of the mount 11. As shown in FIG. 6B, the first pad 121 and the second pad 122 press on the lower eyelid and the upper eyelid, respectively. The correction part 12 is made of an elastic material. The sections connecting the first pad 121 and the second pad 122 with the correction base 120 are deformed when the pressure applied on the eyes is too high. Therefore the pressure applied on the eyes is relieved. This deformation mechanism prevents the eyes from being hurt by the vision correction device 10 due to the high pressure. The pressure applied on the eyes is adjusted to achieve the normal vision. Moreover, the blinking of the illuminant 112 stimulates the pupil to activate the function of contraction and dilation of the pupil.

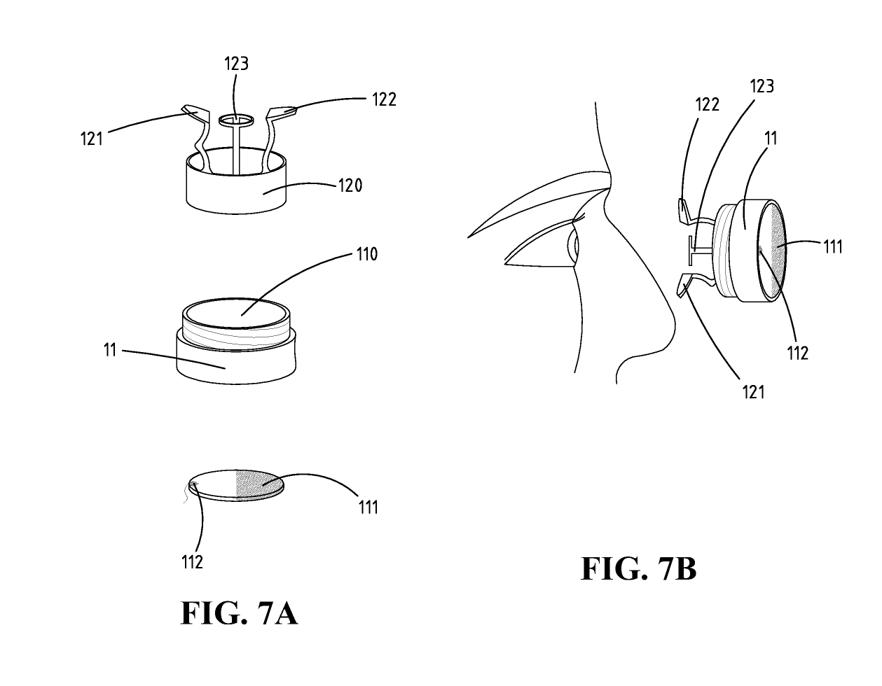

Referring to FIGS. 7A and 7B, a vision correction device 10 according to a fifth embodiment of the present invention comprises a mount 11 shaped into a hollow cylinder and a correction part 12. The mount 11 includes a conjunction part 110, a lens module 111 and an illuminant 112 disposed therein. The correction part 12 has a correction base 120, a first pad 121, a second pad 122, a correction ring 124 (not shown), and a correction ring hoop 123. The first pad 121 and the second pad 122 are disposed on the correction base 120. The correction ring hoop 123 is disposed on the correction base 120 and between the first pad 121 and the second pad 122. The correction ring 124 is telescoped into the correction ring hoop 123. The correction base 120 of the correction part 12 is telescoped into the conjunction part 110 of the mount 11. As shown in FIG. 7B, the first pad 121 and the second pad 122 press on the lower eyelid and the upper eyelid, respectively. The first pad 121, the second pad 122, and the correction ring hoop 123 are made of an elastic material. The sections connecting the first pad 121 and the second pad 122 with the correction base 120 are deformed when the pressure applied on the eyes is too high. Therefore the pressure applied on the eyes is relieved. Moreover, the correction ring 124 slightly presses the cornea to adjust the curvature of the cornea. The sections connecting the correction ring hoop 123 with the correction base 120 are deformed when the pressure applied on the eyes is too high. Therefore the pressure applied on the eyes is relieved. These deformation mechanisms prevent the eyes from being hurt by the vision correction device 10 due to the high pressure. The pressure applied on the eyes is adjusted to achieve the normal vision. Moreover, the lens module 111 of the mount 11 includes a variety of lens, such as a semi-mask, an aperture lens, etc., for different needs. For example, the semi-mask is used to train the adjusting ability of looking at an object closer by or an object far away. The aperture lens is used to train brain to merge two images on the retinas into one. In additional, the blinking of the illuminant 112 stimulates the pupil to activate the function of contraction and dilation of the pupil.

The advantage of the aforementioned vision correction devices is that the device creates the most appropriate state of vision according to the individual user. The feedback reaction of brain gets used to and remembers this corrected state of vision. When the user does not wear the vision correction device, the eye restores the original vision. Then, the feedback reaction of brain adjust the axial length of the eye, the curvature of the crystalline lens, contraction or dilation of the pupil, and convergence of the visual axes to a state of the normal vision.

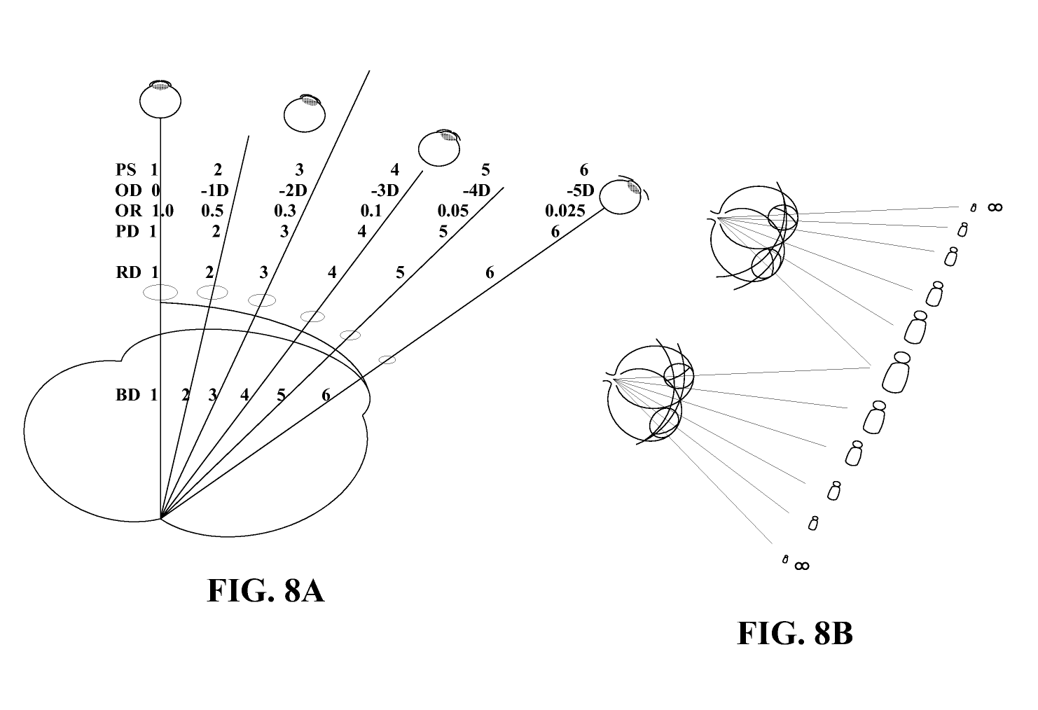

The axial length of eye and the size of the pupil vary according to the distance between an object being watched and the eye. FIG. 8A is a schematic view showing the relation between the axial length of eye and the size of the pupil when looking the object at different distances. The closer the object to the eye is, the bigger the pupil is and the longer the axial length of eye is. When a person looks at an object, the eyes must rotate around a vertical axis so that the projection of the image is in the centre of the retina in both eyes. To look at an object closer by, the eyes rotate towards each other (convergence), while for an object farther away they rotate away from each other (divergence). FIG. 8B is a schematic view showing the characteristics of the visual axes of eyes with respect to the distance between the object and the eyes. The visual axes of eyes converge or diverge respectively, when the object is very close to or far away from the eyes. As shown in FIGS. 8A and 8B, vision correlative motion is composed of contraction or dilation of pupil, change of axial length of eye and convergence of visual axes of eyes. When looking at an object at different distances, contraction or dilation of pupil, axial lengths of eyes and convergence of visual axes of eyes change accordingly.

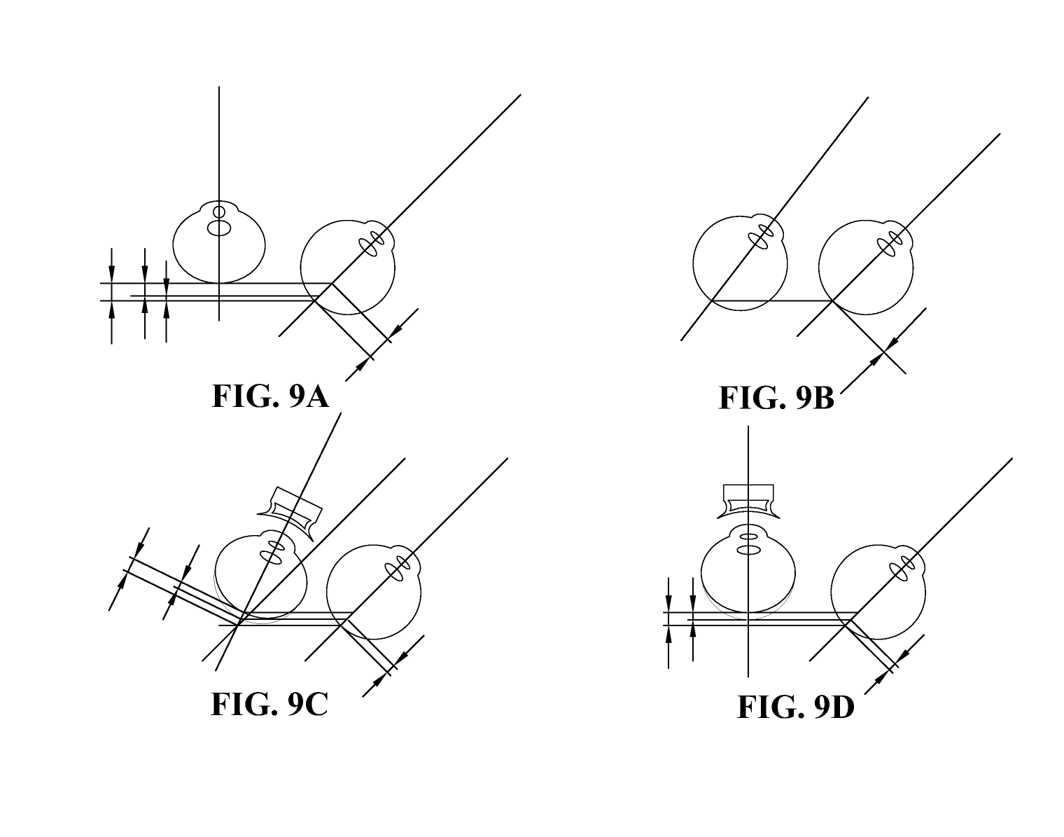

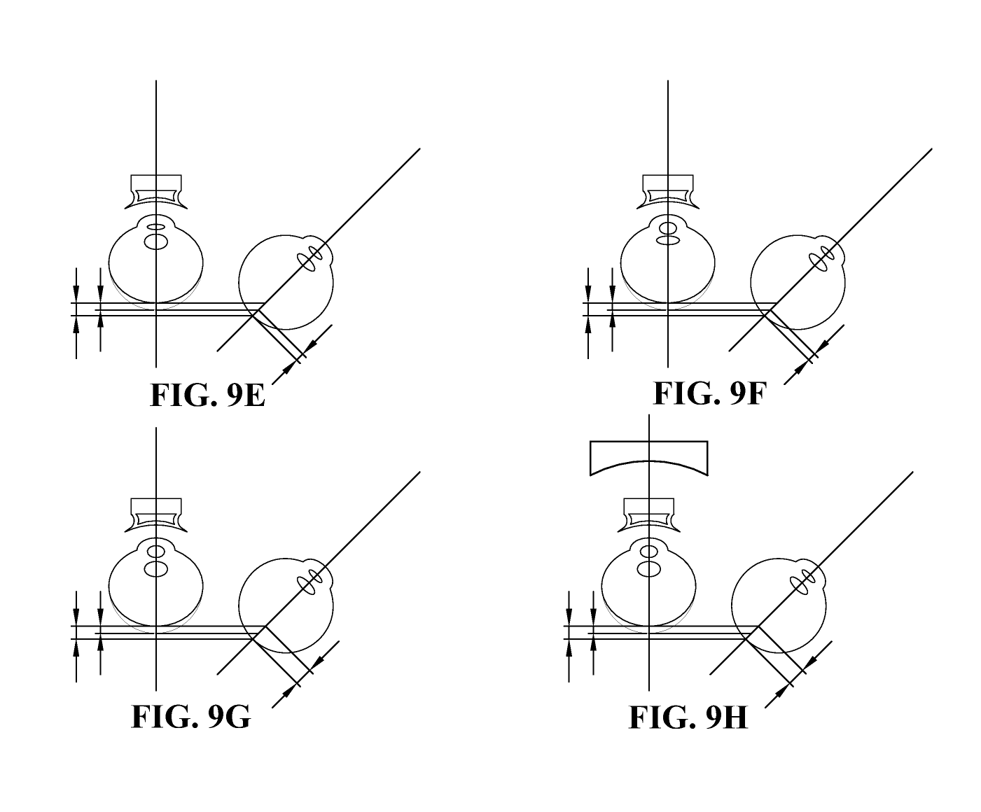

FIG. 9A is a schematic view showing the vision correlative motion of an eye with a normal vision looking at an object closer by and an object far away. When the eye looks at the object far away, the axis of visual axis diverges, the axial length of eye increases and the size of pupil changes. FIG. 9B is a schematic view showing the vision correlative motion of a nearsighted eye looking at an object closer by and an object far away. FIG. 9C is a schematic view showing the vision correlative motion of a nearsighted eye wearing a vision correction device looking at an object closer by and an object far away. The axial length of eye is reduced when the eye wears the vision correction device. FIG. 9D is a schematic view showing the vision correlative motion of a nearsighted eye wearing a vision correction device with a semi-mask looking at an object closer by and an object far away. The visual axis of eye converges or diverges respectively when the eye looks at the object closer by or an object far away. FIG. 9E is a schematic view showing the vision correlative motion of a nearsighted eye wearing a vision correction device with an aperture lens looking at an object closer by and an object far away. FIG. 9F is a schematic view showing the vision correlative motion of a nearsighted eye wearing a vision correction device with an illuminant looking at an object closer by and an object far away. FIG. 9G is a schematic view showing the vision correlative motion of a nearsighted eye wearing a vision correction device with a integrating module, which includes an illuminant and one of a lens module and an activating module, looking at an object closer by and an object far away. FIG. 9H is a schematic view showing the vision correlative motion of a nearsighted eye wearing a vision correction device with an integrating module and eyeglasses, looking at an object closer by and an object far away. As shown in FIGS. 9A to 9H, when nearsighted eyes look at an object far away, the vision mechanism does not work well. The vision correction device shortens the axial length of eyes, creates a temporary state of normal vision, and activates the vision correlative motion. Moreover, the stimulation of the vision correction device with integrating module makes eyes to achieve a normal vision no matter looking at an object closer by or far away.

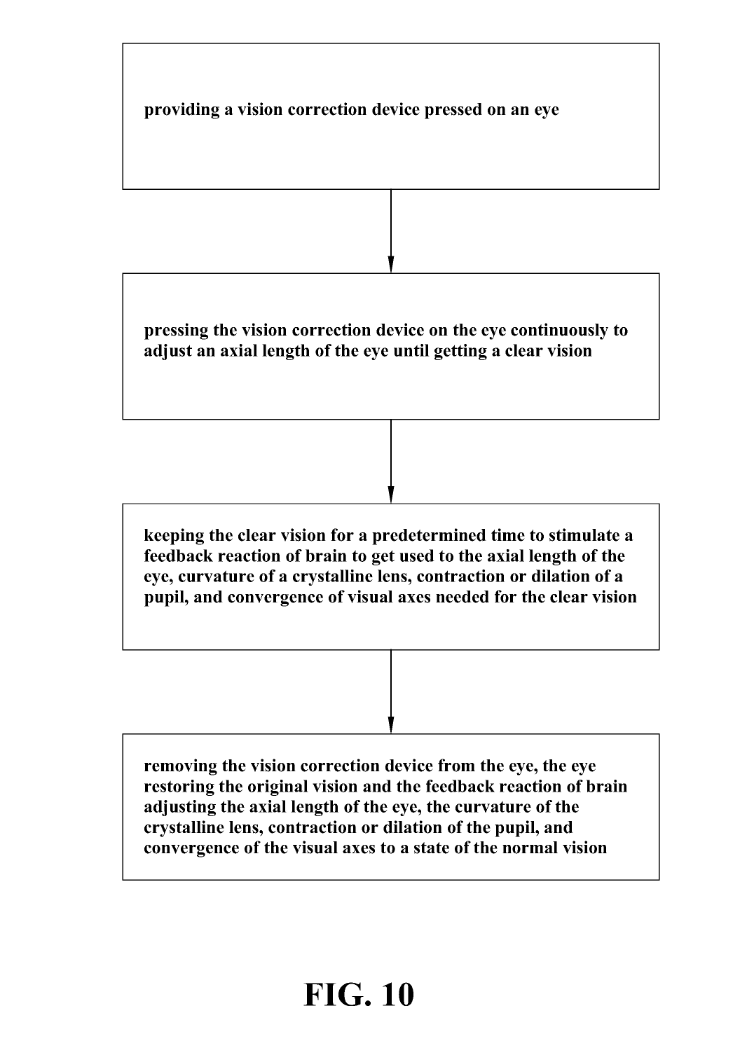

FIG. 10 is a flow chart showing a method for vision correction according to a first embodiment of the present invention. As shown in FIG. 10, the method for vision correction according to the present invention comprises the following steps: (1) providing a vision correction device pressed on an eye; (2) pressing the vision correction device on the eye continuously to adjust an axial length of the eye until getting a clear vision; (3) keeping the clear vision for a predetermined time to stimulate a feedback reaction of brain to get used to the axial length of the eye, curvature of a crystalline lens, contraction or dilation of a pupil, and convergence of visual axes needed for the clear vision; and (4) removing the vision correction device from the eye, the eye restoring the original vision and the feedback reaction of brain adjusting the axial length of the eye, the curvature of the crystalline lens, contraction or dilation of the pupil, and convergence of the visual axes to a state of the normal vision.

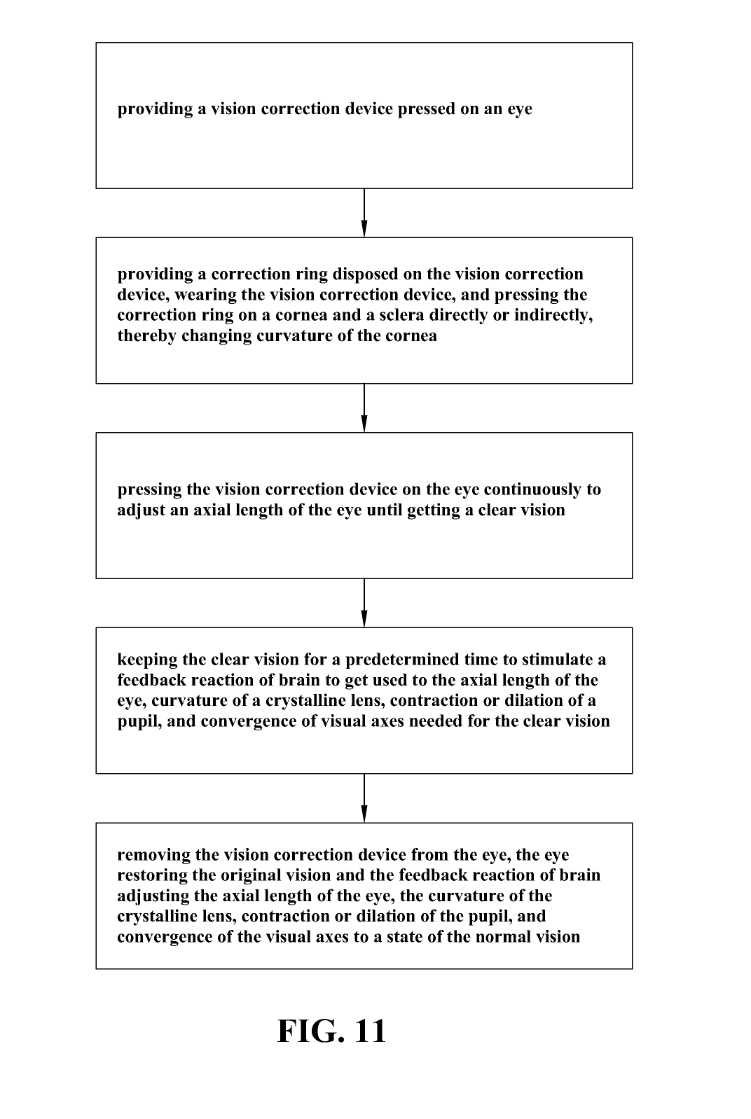

FIG. 11 is a flow chart showing a method for vision correction according to a second embodiment of the present invention. As shown in FIG. 11, the method for vision correction in accordance with the present invention comprises the following steps: (1) providing a vision correction device pressed on an eye; (2) providing a correction ring disposed on the vision correction device, wearing the vision correction device, and pressing the correction ring on a cornea and a sclera directly or indirectly (through an eyelid), thereby changing curvature of the cornea; (3) pressing the vision correction device on the eye continuously to adjust an axial length of the eye until getting a clear vision; (4) keeping the clear vision for a predetermined time to stimulate a feedback reaction of brain to get used to the axial length of the eye, curvature of a crystalline lens, contraction or dilation of a pupil, and convergence of visual axes needed for the clear vision; and (5) removing the vision correction device from the eye, the eye restoring the original vision and the feedback reaction of brain adjusting the axial length of the eye, the curvature of the crystalline lens, contraction or dilation of the pupil, and convergence of the visual axes to a state of the normal vision.

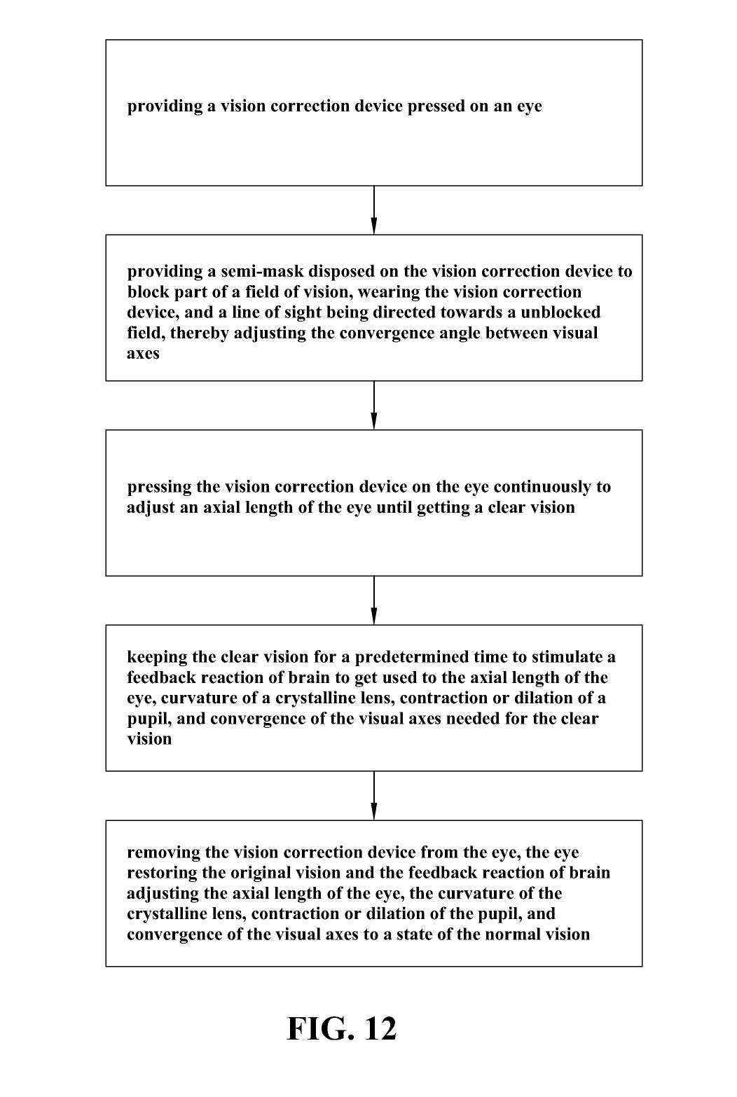

FIG. 12 is a flow chart showing a method for vision correction according to a third embodiment of the present invention. As shown in FIG. 12, the method for vision correction of the present invention comprises the following steps: (1) providing a vision correction device pressed on an eye; (2) providing a semi-mask disposed on the vision correction device to block part of a field of vision, wearing the vision correction device, and a line of sight being directed towards a unblocked field, thereby adjusting the convergence angle between visual axes; (3) pressing the vision correction device on the eye continuously to adjust an axial length of the eye until getting a clear vision; (4) keeping the clear vision for a predetermined time to stimulate a feedback reaction of brain to get used to the axial length of the eye, curvature of a crystalline lens, contraction or dilation of a pupil, and convergence of the visual axes needed for the clear vision; and (5) removing the vision correction device from the eye, the eye restoring the original vision and the feedback reaction of brain adjusting the axial length of the eye, the curvature of the crystalline lens, contraction or dilation of the pupil, and convergence of the visual axes to a state of the normal vision.

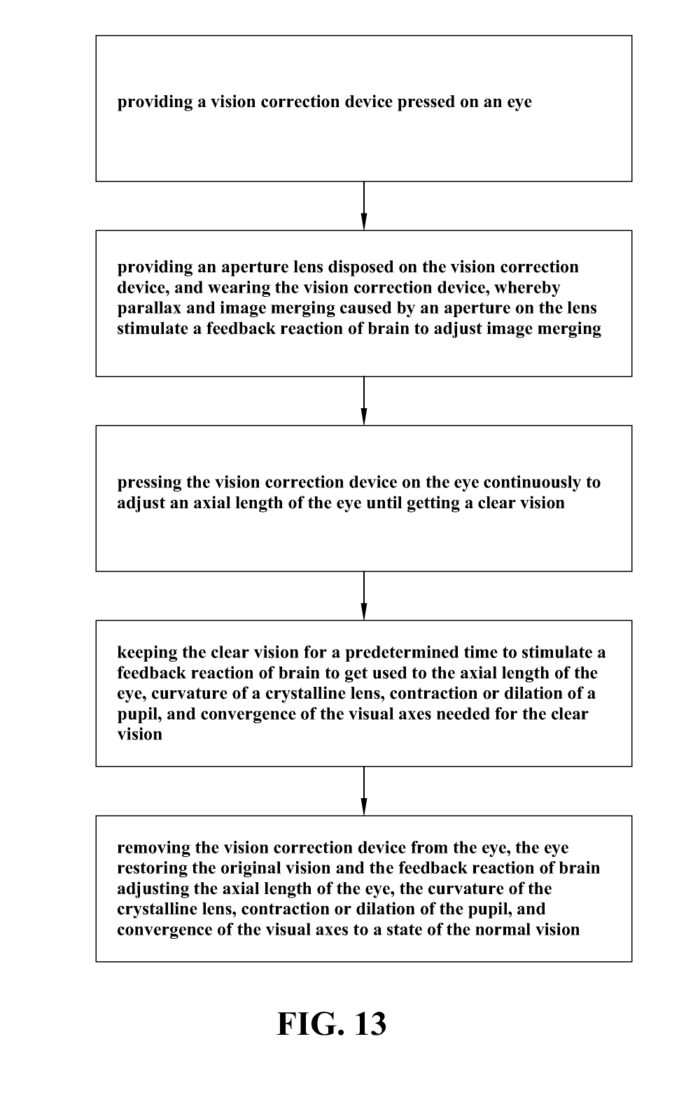

FIG. 13 is a flow chart showing a method for vision correction according to a fourth embodiment of the present invention. As shown in FIG. 13, the method for vision correction in accordance with the present invention comprises the following steps: (1) providing a vision correction device pressed on an eye; (2) providing an aperture lens disposed on the vision correction device, and wearing the vision correction device, whereby parallax and image merging caused by an aperture on the lens stimulate a feedback reaction of brain to adjust image merging; (3) pressing the vision correction device on the eye continuously to adjust an axial length of the eye until getting a clear vision; (4) keeping the clear vision for a predetermined time to stimulate a feedback reaction of brain to get used to the axial length of the eye, curvature of a crystalline lens, contraction or dilation of a pupil, and convergence of the visual axes needed for the clear vision; and (5) removing the vision correction device from the eye, the eye restoring the original vision and the feedback reaction of brain adjusting the axial length of the eye, the curvature of the crystalline lens, contraction or dilation of the pupil, and convergence of the visual axes to a state of the normal vision.

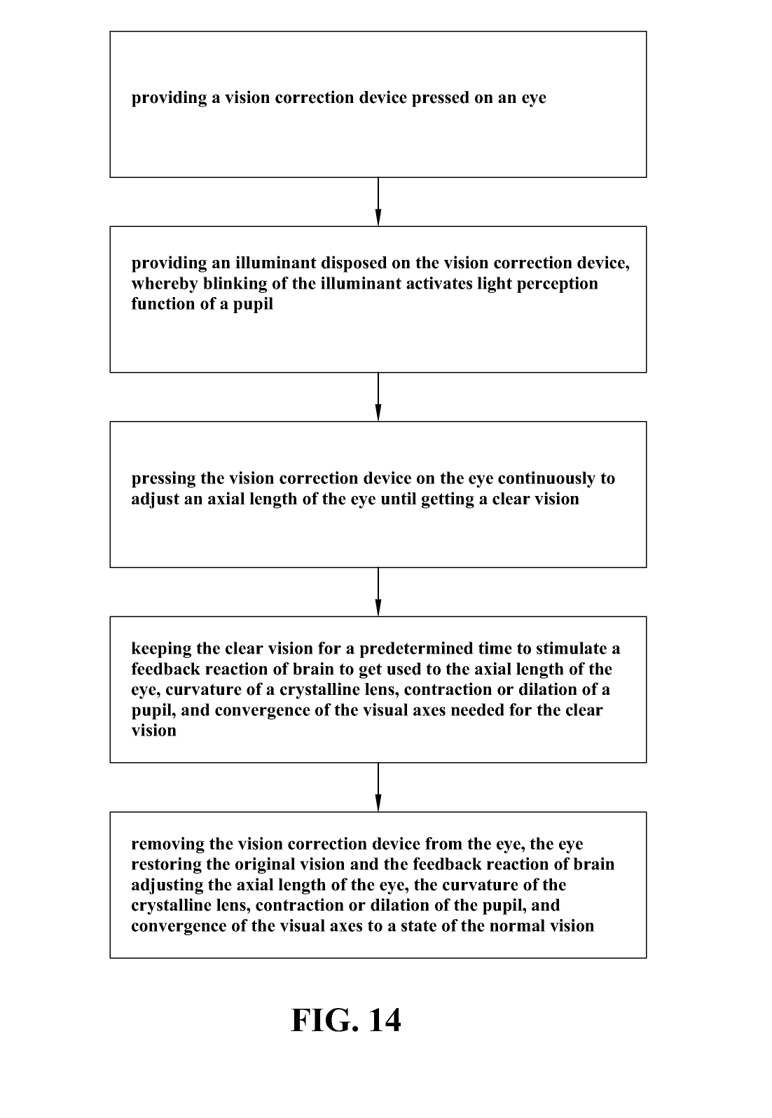

FIG. 14 is a flow chart showing a method for vision correction according to a fifth embodiment of the present invention. As shown in FIG. 14, the method for vision correction of the present invention comprises the following steps: (1) providing a vision correction device pressed on an eye; (2) providing an illuminant disposed on the vision correction device, whereby blinking of the illuminant activates light perception function of a pupil; (3) pressing the vision correction device on the eye continuously to adjust an axial length of the eye until getting a clear vision; (4) keeping the clear vision for a predetermined time to stimulate a feedback reaction of brain to get used to the axial length of the eye, curvature of a crystalline lens, contraction or dilation of a pupil, and convergence of the visual axes needed for the clear vision; and (5) removing the vision correction device from the eye, the eye restoring the original vision and the feedback reaction of brain adjusting the axial length of the eye, the curvature of the crystalline lens, contraction or dilation of the pupil, and convergence of the visual axes to a state of the normal vision.

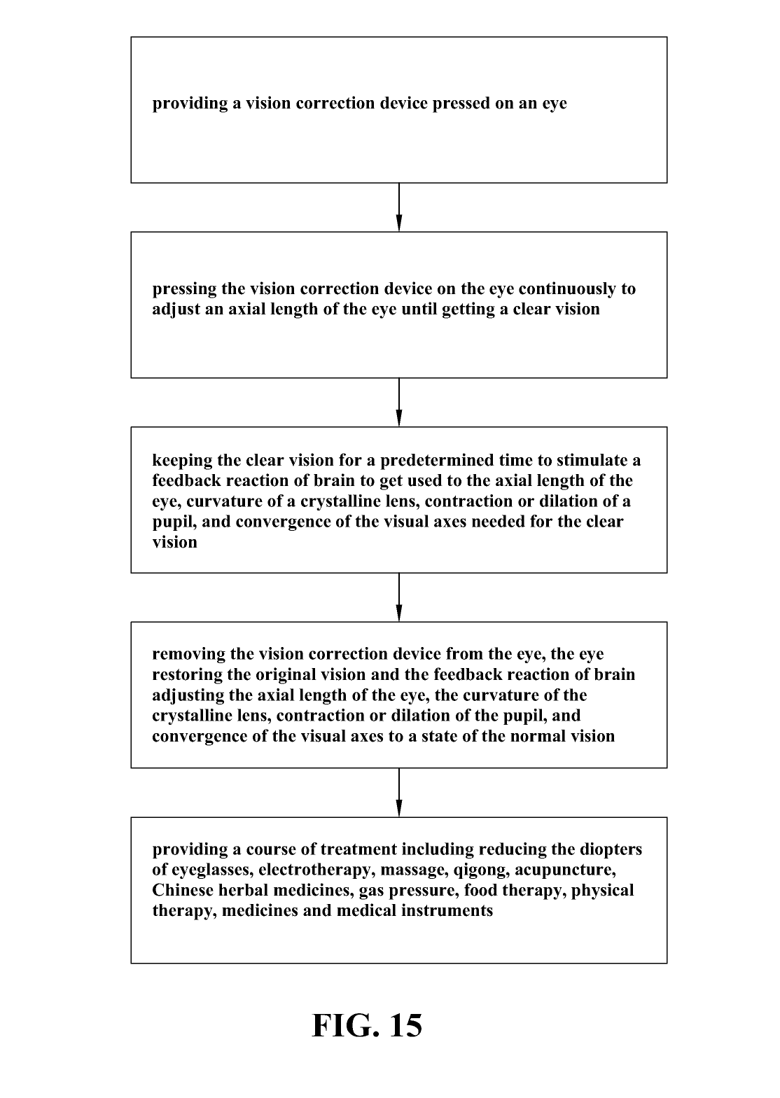

FIG. 15 is a flow chart showing a method for vision correction according to a sixth embodiment of the present invention. As shown in FIG. 15, the method for vision correction in accordance with the present invention comprises the following steps: (1) providing a vision correction device pressed on an eye; (2) pressing the vision correction device on the eye continuously to adjust an axial length of the eye until getting a clear vision; (3) keeping the clear vision for a predetermined time to stimulate a feedback reaction of brain to get used to the axial length of the eye, curvature of a crystalline lens, contraction or dilation of a pupil, and convergence of the visual axes needed for the clear vision; and (4) removing the vision correction device from the eye, the eye restoring the original vision and the feedback reaction of brain adjusting the axial length of the eye, the curvature of the crystalline lens, contraction or dilation of the pupil, and convergence of the visual axes to a state of the normal vision; and (5) providing a course of treatment includes reducing the diopters of eyeglasses, electrotherapy, massage, qigong, acupuncture, Chinese herbal medicines, gas pressure, food therapy, physical therapy, medicines and medical instruments.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A vision correction device, comprising:
a mount in a hollow cylinder shape; and
a correction part comprising a correction base, a first pad and a second pad, wherein the first pad and the second pad are disposed on the correction base, and the correction base is telescoped into the mount.

2. The device as claimed in claim 1, wherein the correction part is made of an elastic material.

3. The device as claimed in claim 1, wherein the correction part further comprises a correction ring hoop, wherein the correction ring hoop is disposed on the correction part and between the first pad and the second pad.

4. The device as claimed in claim 1, wherein the mount further comprises a lens module disposed therein.

5. The device as claimed in claim 1, wherein the mount further comprises an illuminant disposed thereon.

6. The vision correction device as claimed in claim 3, wherein the correction ring hoop has a correction ring telescoped thereinto.

7. The vision correction device as claimed in claim 6, wherein the correction ring has an activating module disposed therein.

8. A method for vision correction comprising the following steps:
providing a vision correction device pressed on the eyes;
pressing the vision correction device on the eye continuously to adjust an axial length of the eye until getting a clear vision;
keeping the clear vision for a predetermined time to activate a feedback reaction of brain to get used to the axial length of the eye, curvature of a crystalline lens, contraction or dilation of a pupil, and convergence of the visual axes needed for the clear vision; and
removing the vision correction device from the eye, the eye restoring an original vision and the feedback reaction of brain adjusting the axial length of the eye, the curvature of the crystalline lens, contraction or dilation of the pupil, and convergence of the visual axes to a state of the normal vision.

9. The method as claimed in claim 8, further comprising a step of providing a correction ring disposed on the vision correction device, wearing the vision correction device, and pressing the correction ring on a cornea and a sclera directly or indirectly, thereby changing curvature of the cornea.

10. The method as claimed in claim 8, further comprising a step of providing a semi-mask disposed on the vision correction device to block part of a field of vision, wearing the vision correction device, and a line of sight being directed towards a unblocked field, thereby adjusting the convergence angle between visual axes.

11. The method as claimed in claim 8, further comprising a step of providing an aperture lens disposed on the vision correction device, and wearing the vision correction device, whereby parallax and image merging caused by an aperture on the lens stimulate a feedback reaction of brain to adjust image merging.

12. The method as claimed in claim 8, further comprising a step of providing an illuminant disposed on the vision correction device, whereby blinking of the illuminant activates light perception function of a pupil.

13. The method as claimed in claim 8, further comprising a step of providing a course of treatment including reducing the diopters of eyeglasses, electrotherapy, massage, qigong, acupuncture, Chinese herbal medicines, gas pressure, food therapy, physical therapy, medicines and medical instruments.
